(19) United States
(12) Patent Application Publication
(10) Pub. No.: US 2005/0205580 A1
(43) Pub. Date: Sep. 22, 2005

(54) Reverse flange collar adapter and reverse flange collar

(76) Inventors: Michael G. Zais, Lakeville, MN (US); Cary D. Etter, Abilene, TX (US)

Correspondence Address: Supervisor, Patent Prosecution Services;PIPER RUDNICK LLP, 1200 Nineteenth Street, N.W., Washington, DC, 20036-2412, US

(21) Appl. No.: 10/801,854

(22) Filed: Mar. 17, 2004

(51) Int. Cl. G01F 23/00

(52) U.S. Cl. 220/567.1

(57) ABSTRACT

An underground storage tank system includes an underground storage tank having an attached collar, a reverse flange collar adapter with a lower portion sized to mate with the attached collar and an upper portion having an inwardly projecting adapter flange sized and configured to mate with a corresponding, inwardly projecting riser flange. The adaptor permits the use of dissimilar material in the top and adapter. In some embodiments, the adapter and riser flanges have a plurality of holes formed therein, the holes being sized to accept bolts for securing the riser flange to the adapter flange. Another system includes a tank with an attached collar having an inwardly projecting flange that mates with an inwardly projecting flange on a riser.

### BACKGROUND OF THE INVENTION

1. Field of the Invention

The invention relates to an adapter for coupling a riser to a collar on an underground storage tank and a collar with a reverse flange.

2. Discussion of the Background

Underground storage tanks are used in a wide variety of locations to store materials underground. These tanks are made from a variety of materials, including steel and fiber reinforced plastic (FRP). Larger underground storage tanks often include an opening, referred to in the art as a manway, through which a human being can enter the interior of the tank, which may be necessary from time to time to check for leaks and/or repair a damaged tank. In order to provide access to the manway from above ground, and to house fittings, flex pipes and other devices, it is known to provide a cylindrical housing, referred to in the art as a riser. The riser is typically attached to the tank, surrounds the manway and typically extends upward from the tank to slightly below ground level. The riser is usually provided with a removable riser cover. Access to the riser cover is provided by what is sometimes referred to in the art as a street box, which is typically at ground level and includes yet another removable cover that is accessible from ground level.

The materials stored in underground storage tanks are often harmful to the environment. Examples of such materials include gasoline, oil, waste oil, and other petroleum products, e.g., oil, waste oil, and toxic raw materials and waste from manufacturing processes. Because of the harmful nature of these materials, it is especially important to ensure that underground storage tanks containing such materials do not release these materials into the environment.

Concern over this possibility has lead many governmental authorities to require secondary containment for tanks that store such materials. One of the most common methods for providing secondary containment is through the use of double walled underground storage tanks. The assignee of the present application, Xerxes Corporation, has manufactured and sold double walled underground storage tanks prepared from corrosion resistant materials such as FRP since 1984. These tanks have proven very reliable.

However, no matter how reliable the underground storage tank itself is, there is always the possibility that the pipes connected to the tank may fail. In recognition of this possibility, the use of double-walled piping has come into practice. Double walled piping includes an inner wall separated from an outer, or second, wall. The inner wall provides a passage for fluid between the inside of the underground storage tank and a desired destination. The outer wall of the double walled piping prevents any fluid escaping from a breach in the inner wall from leaking into the ground, thereby providing the secondary containment function.

In such double walled piping installations, the riser is typically used as a containment sump. The riser containment sump is in fluid communication with the annulus formed by the two walls of the piping so fluid leaking from the inner wall of the pipe will be carried by the outer wall to and contained by the riser sump. An example of a double-walled piping/underground storage tank installation with a single wall riser containment sump is illustrated in U.S. Pat. No. 4,639,164 to Pugnale et al. A sensor is typically placed at the bottom of the sump so that any leaks are detected. In order for the sump to function properly, the sump must be watertight. An exemplary water-tight riser is described in U.S. Pat. No. 5,595,456, also assigned to Xerxes Corp. In this patent, the riser and the sump must be made of the same material or at least be made of materials that are amenable to the formation of an adhesive bonded joint between the two materials.

### SUMMARY OF THE INVENTION

The aforementioned issues are addressed to a great extent by the versatility of the present invention, which, in one embodiment, provides an underground storage tank having an attached collar, an adapter with a lower portion sized to mate with the attached collar and an upper portion having an inwardly projecting adapter flange sized and configured to mate with a corresponding, inwardly projecting riser flange. In preferred embodiments, the adapter and riser flanges have a plurality of holes formed therein, the holes being sized to accept fasteners such as bolts for securing the riser flange to the adapter flange. In another embodiment, an underground storage tank includes a collar with an inwardly projecting flange.

### BRIEF DESCRIPTION OF THE DRAWINGS

The aforementioned advantages and features of the present invention will be more readily understood with reference to the following detailed description and the accompanying drawings in which:

FIG. 1 illustrates a conventional underground storage tank installation including a riser sump and associated double wall piping.

FIG. 2 is side cross sectional view of a portion of the underground storage tank installation of FIG. 1 illustrating an attached collar and riser in greater detail.

FIG. 3 is a side cross sectional view of the attached collar of FIG. 2.

FIG. 4 is perspective view of a portion of an underground storage tank having a riser coupled to it by a reverse flange collar adapter according to an embodiment of the present invention.

FIG. 5 is a side cross sectional view of a portion of the underground storage tank of FIG. 4.

FIG. 6 is a side cross sectional view of a conventional riser.

FIG. 7 is a side cross sectional view of another conventional riser.

FIG. 8 is a perspective view of an underground storage tank having an attached collar with a reverse flange according to another embodiment of the invention.

### DETAILED DESCRIPTION

In the following detailed description, a plurality of specific details, such as riser dimensions and types of riser material, are provided in order to provide a thorough understanding of the present invention. The details discussed in connection with the preferred embodiments should not be understood to limit the present invention. Furthermore, for ease of understanding, certain method steps are delineated as separate steps; however, these steps should not be construed as necessarily distinct nor order dependent in their performance.

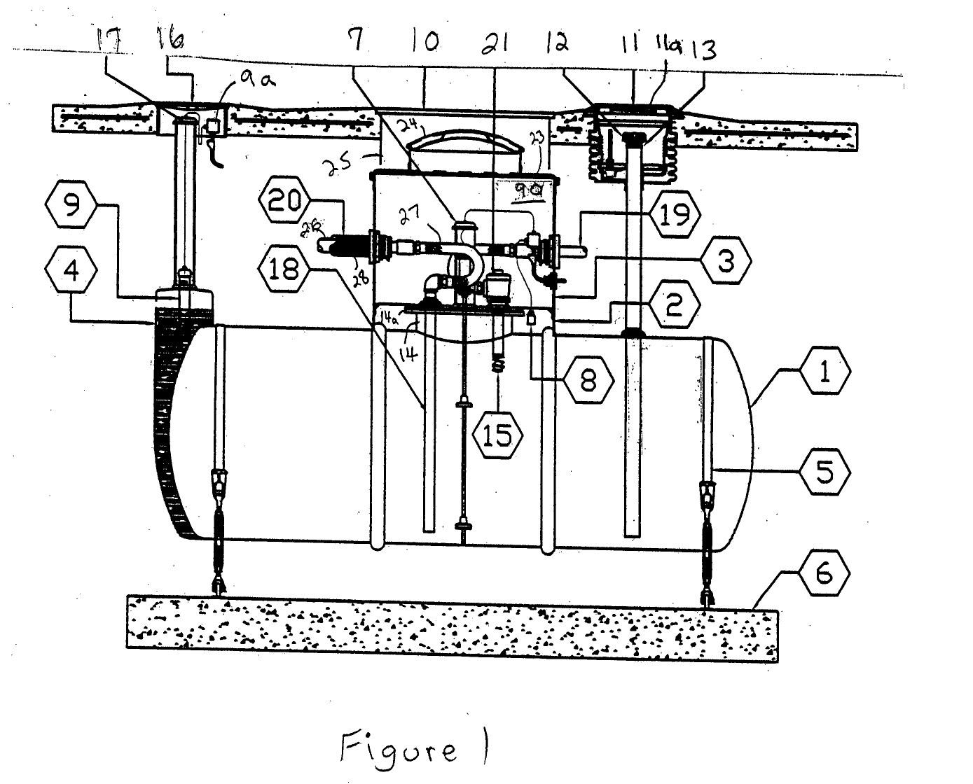

FIG. 1 illustrates a typical underground storage tank installation, in this case, a gasoline tank installation, including a riser sump and double walled piping. An underground storage tank (“UST”) 1, in this case a double walled fiberglass UST, is secured by a pair of retaining straps 5 attached to a pair of deadmen 6 (one of which is visible in FIG. 1). The deadmen 6 may be of a conventional type or may be of the type described in U.S. patent application Ser. No. 10/163,368, entitled “Low Profile Deadman And Method For Shipping The Same With a Tank”, filed on Jun. 7, 2002, and owned by Xerxes Corp. As is well known in the art, the straps 5 and deadmen 6 are sometimes necessary to prevent flotation of the UST 1 in the presence of a high water table. Other types of retaining systems, including above and below ground slabs, may also be used.

The double-walled UST 1 includes a hydrostatic monitoring system 4. The hydrostatic monitoring system monitors the level of a monitoring fluid, typically brine, between the two walls of the double walled UST 1. The hydrostatic monitoring system 4 includes a monitoring sensor 9 connected to a communication module 9a through tube 17. The tube 17 is accessible via access cover 16. The hydrostatic monitoring system 4 is used with a double walled UST 1 having a wet annulus. The interior of the UST 1 may be filled from ground level by removing the cover 11a from the spill containment sump 11, which provides access to the fill cap 12 covering the fill tube 13.

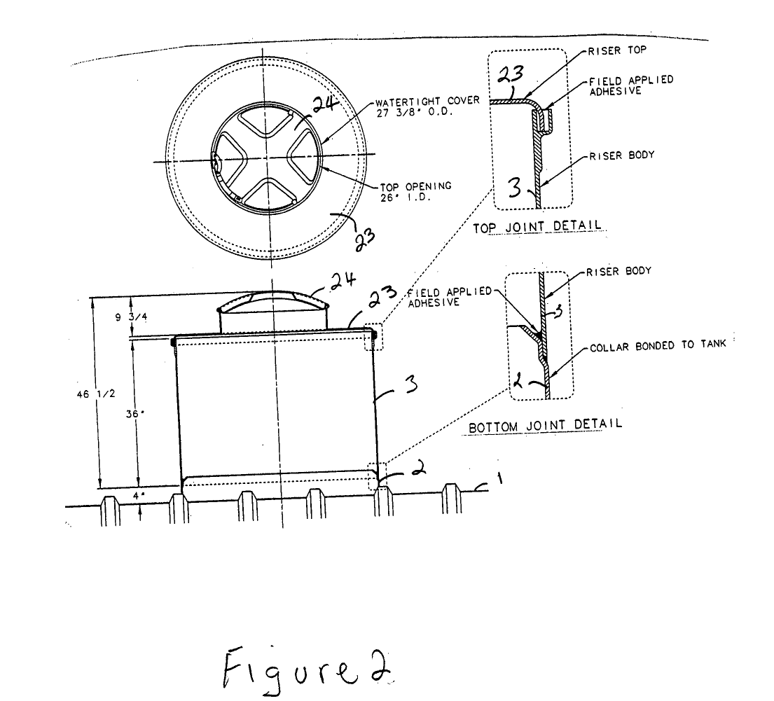

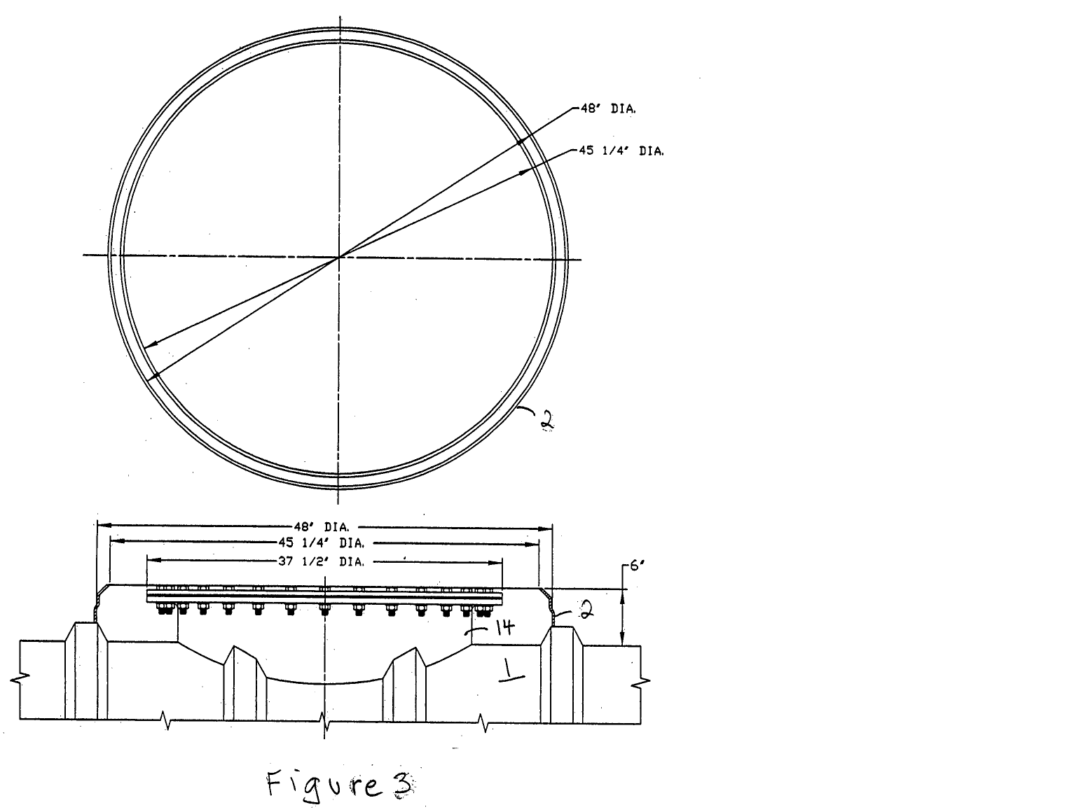

The UST 1 includes a collar 2 to which is attached a riser 3. The collar 2 and riser 3 surround a manway 14 covered by a manway cover 14a. A riser cover 23 sits atop the riser 3. The riser cover 23 includes a removable domed cover 24. The collar 2, riser 3, riser cover 23 and domed cover 24 together form a watertight compartment that together form a containment sump 90. An access way 25 (which is sometimes referred to as a street box) and ground level access way cover 10 provide access to the domed riser cover 24. The access way 25 and access way cover 10 are not part of the sump and are not necessarily water tight. FIG. 2 illustrates the collar 2, riser 3, riser cover 23 and domed cover 24 in greater detail (the manway 14 is not shown in FIG. 2). FIG. 3 illustrates the collar 2 in still greater detail. The connection between the collar 2 and the riser 3 is typically made with a fiberglass lay up in the field.

Referring now back to FIG. 1, a level probe 7 is disposed within the sump 90 and passes through the manway cover 14a to monitor the level of fluid within the UST 1. A single walled vent pipe 19 is connected to the housing for the level probe 7 and passes through the wall of the riser 3 to provide venting for the UST 1. Also disposed within the sump 90 is an extractor assembly 21, which is connected through the manway cover 14a to ball float 15 in the interior of UST 1.

A double walled pipe 20 carries gasoline to the UST 1. The double walled pipe 20 passes through a side of riser 3. The interior wall 26 of double walled pipe 20 is connected, via flex connector 27, to a pipe 18 passing through the manway cover 14a to the interior of the UST 1. The space between the outer wall 28 and inner wall 26 of double wall pipe 20 is in fluid communication with the sump 90. As discussed above, any fluid leaking from interior wall 26 of double wall pipe 20 will be contained by outer wall 28 and transported to sump 90 for containment. A sensor 8 detects any fluid in sump 90 and triggers an alarm system (not shown in FIG. 1).

It will be understood by those of skill in the art that the foregoing installation is but one of may possible installations. It should also be understood that not all installations employ double walled piping, and that not all risers are employed as containment sumps. Indeed, some risers are used simply to provide access to a manway of an underground storage tank and do not have any pipe, double-walled or other, passing through their walls. The invention should not be understood to be limited to any particular type of installation.

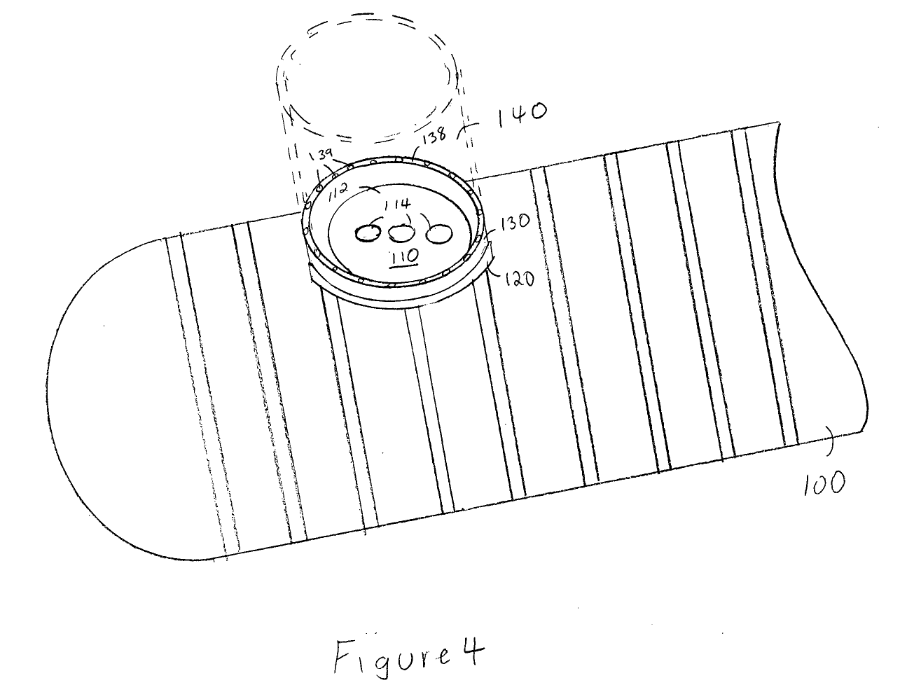

FIG. 4 illustrates a perspective view of an underground storage tank 100 according to an embodiment of the present invention. The underground storage tank 100 may be made of any material but is preferably formed of fiber reinforced plastic (FRP), also referred to as fiberglass. The tank 100 includes a manway 110. The manway 110 includes a cover 112 through which a plurality of openings 114 have been formed. As will be understood by those of skill in the art, the openings are used in installations in devices that communicate with the interior of the UST 100, such as the flex pipe 27, level probe 7, and ball float 15 of FIG. 1. The UST 100 has an attached collar 120 surrounding the manway. Attached to the collar is a reverse flange collar adapter RFCA 130, to which is attached a riser 140 (shown in phantom in FIG. 2).

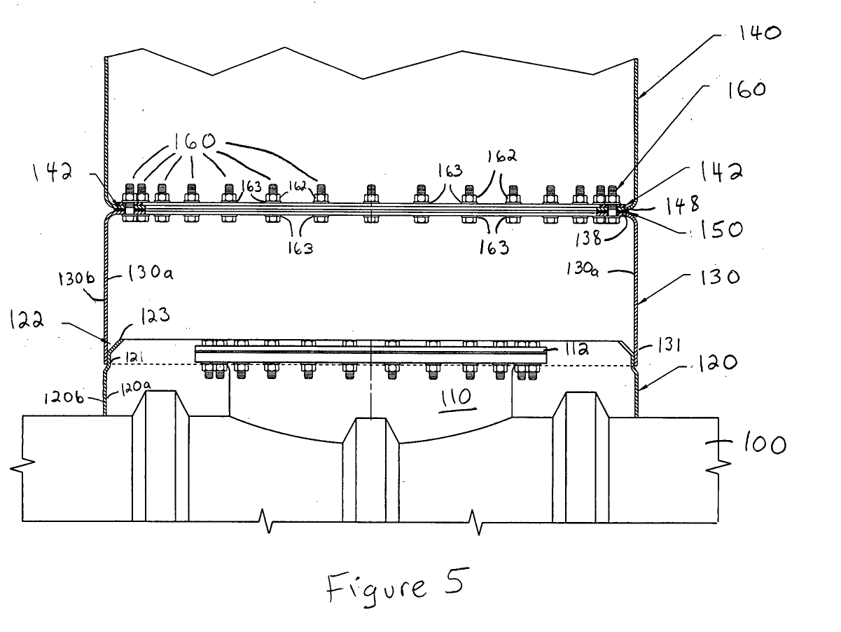

The collar 120, RFCA 130 and riser 140 are illustrated in greater detail in FIG. 5, which is a side cross sectional view of the UST 100 of FIG. 4. The collar 120 is attached to the UST 100 in a conventional manner. If the riser 140 is to be used as a containment sump, the joint between the collar 120 and UST 100 is watertight and typically, but not necessarily, made at the factory. The collar 120 preferably includes a recess 121 sized to accept the bottom end of the RFCA 130. The RFCA 130 may be attached to the collar 120 at the factory or in the field. Preferably an adhesive/sealant, such as the polyurethane sealant sold under the mark BOSTIK 920 FAST SET, is used to seal the inner wall 130a of the riser 130 to the outer surface of the recess 121. Once the RFCA 130 is in place over the collar 120, a band (sometimes referred to in the art as a “lay up”) of FRP is deposited around the joint between the collar 120 and the RFCA 130 outer walls 120b, 130b. This band preferably forms a watertight joint. The gap 122 between the upper edge 123 of the collar 120 and the bottom of the RFCA 130 is optionally filled with a filler material or an adhesive such as that described above.

The top end RFCA 130 the adapter top includes an inwardly projecting adapter flange 138 that is sized and configured to mate with a corresponding flange 148 of the riser 140. The adapter flange 138 has a plurality of holes 139 formed therein. Each of the holes 139 are sized to accept a bolt 160 which, together with a corresponding nut 162 and associated washers 163, secures the adapter flange 138 to the riser flange 148. A gasket 150 is preferably interposed between the adapter flange 138 and the riser flange 148 to seal the joint between the flanges 138, 148. A compression ring 142 may be used on the side of the riser flange 148 opposite the adapter flange 138. The upper portion of the riser 140 (not shown in FIG. 5) is conventional and may include a cover such as the watertight cover 24 of FIG. 1.

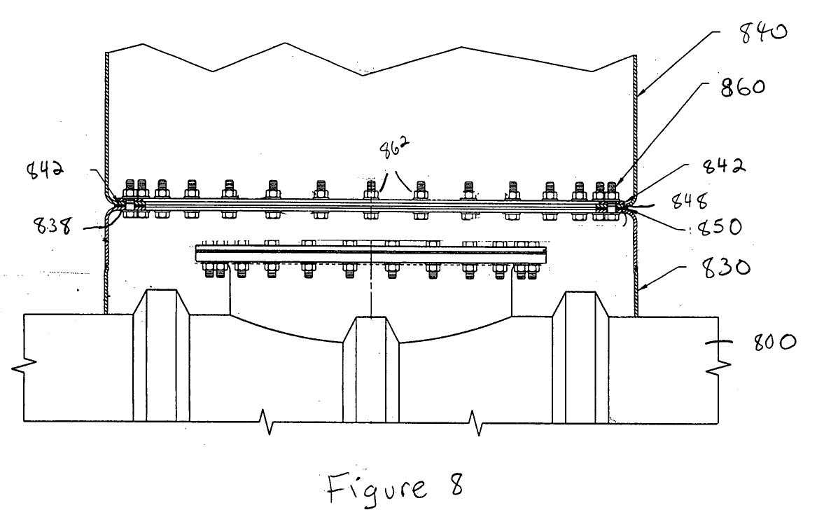

Another embodiment of the invention is illustrated in FIG. 8, which is a side cross sectional view of an underground storage tank 800 with a reverse flange attached collar 830. The attached collar 830 includes a reverse flange 838 that mates with a reverse flange 848 of a riser 840. The riser 840 may be secured to the collar 830 using bolts 860, nuts 862, a gasket 850 and a compression ring 842 similar to the manner described above in connection with FIG. 5.

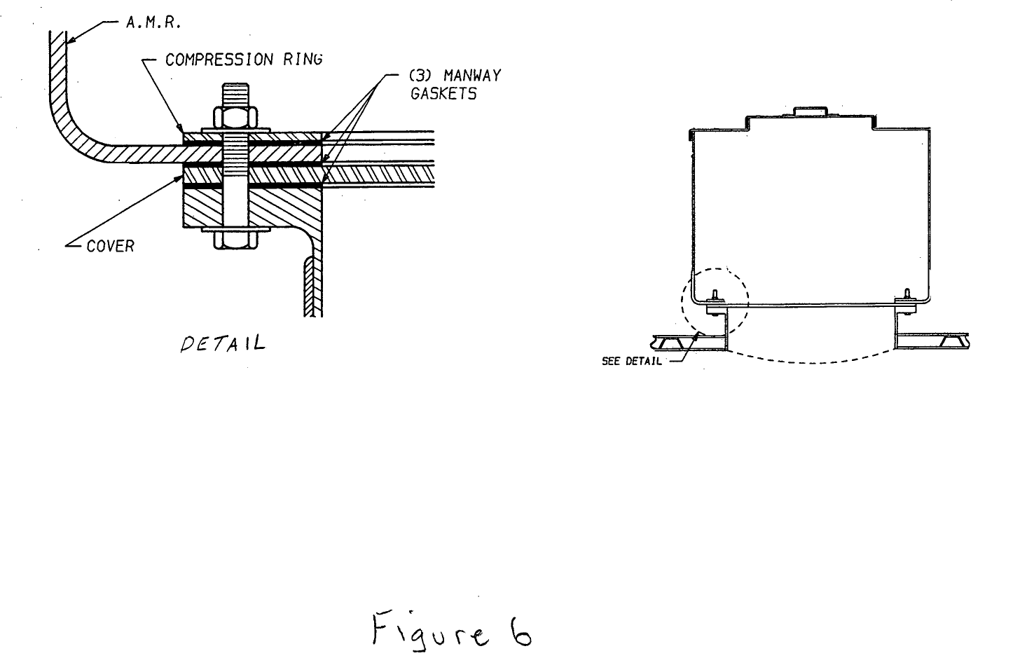

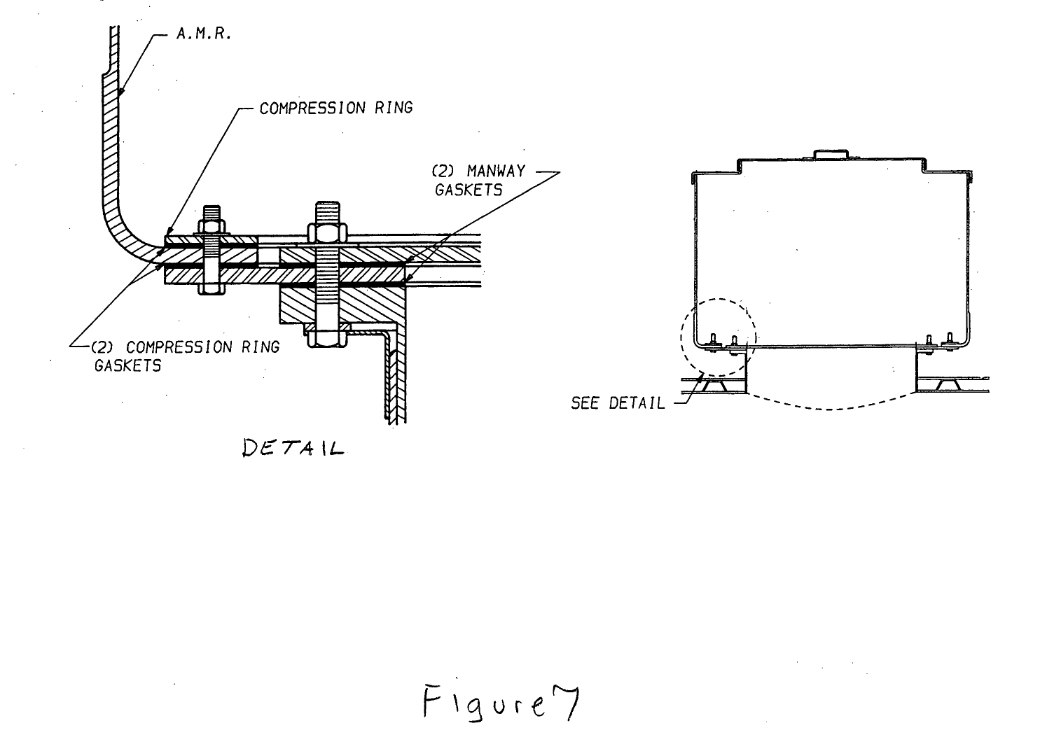

A significant feature of the present invention is the inward orientation of the flange 138 of the adapter 130 and the flange 838 of the collar 830. Typical flanges (such as those shown in FIGS. 6 and 7) would have an outward orientation to facilitate installation of the riser 140 to the adapter 130 so that the bolts and nuts can be tightened from the outside of the riser. This is why the inward flange is referred to herein as a “reverse flange.” The reverse flange of the present invention has an important advantage vis-a-vis the conventional, outward flange—any fluid leaking between the riser and the flanges 138, 838 will be contained by the collar/adapter/riser. This is especially important in embodiments of the invention in which the riser is used as a containment sump.

Another feature of those embodiments of the present invention that use mechanical means (such as nuts and bolts, clips, or other fasteners) to secure the joint between the flanges of the riser and reverse flange collar adapter or the reverse flange collar is that the reverse flange collar adapter or reverse flange collar can be secured to the collar at the factory or at some other time before the tank is installed whereas the riser can be installed in the field. This avoids the need to form a fiberglass joint between the riser and the collar at the installation site with the tank in its final position as is typically done for the joint between conventional risers and collars such as those illustrated in FIGS. 1 and 2. Installation is thereby simplified and shortened. Additionally, the use of mechanical means to secure the riser to the adapter facilitates the use of different materials in the adapter and the riser. For example, in some embodiments, the riser is formed from polypropylene and the adapter is formed from FRP.

The reverse flange collar adapter and the reverse flange collar may be used with any type of storage tank, including steel and FRP tanks, whether single or multi-walled, and with any type of riser, whether used as a containment sump, simply to provide access to a manway, or otherwise. The joint between the flanges of the reverse flange collar adapter and the riser may be made by mechanical means (including, but not limited to nuts and bolts as illustrated above) and other methods (e.g., adhesive, FRP).

Obviously, numerous modifications and variations of the present invention are possible in light of the above teachings. It is therefore to be understood that within the scope of the appended claims, the invention may be practiced otherwise than as specifically described herein.

1. An underground storage system comprising:
an underground storage tank, the underground storage tank having a collar attached thereto;
a riser, the riser having a sidewall including a bottom end and a top end, the bottom end having an annular, inwardly projecting riser flange attached thereto;
an adapter connected between the collar and the riser, the adapter having an adapter top and an adapter bottom, the adapter bottom being sized and configured to mate with the collar, the adapter top including an inwardly projecting adapter flange sized and configured to mate with the riser flange.

2. The underground storage system of claim 1, wherein the underground storage tank includes a manway positioned in an interior of the collar.

3. The underground storage system of claim 1, further comprising a plurality of fasteners positioned to secure the adapter flange to the riser flange, wherein the adapter flange and the riser flange each have a plurality of holes formed therein, each of the holes being sized to accept at least one of the fasteners.

4. The underground storage system of claim 1, further comprising at least one double walled pipe, the double walled pipe having an inner pipe and an outer pipe forming an annular space therebetween, wherein the riser is adapted to form a containment sump together with the collar and the adapter, the annular space being in fluid communication with an interior of the containment sump.

5. The underground storage system of claim 1, wherein the underground storage tank is a double-walled underground storage tank.

6. The underground storage system of claim 1, wherein the underground storage tank and the adapter are formed from fiber reinforced plastic (FRP).

7. The underground storage system of claim 6, wherein the riser is formed from FRP.

8. The underground storage system of claim 6, wherein the riser is formed from polypropylene.

9. The underground storage system of claim 1, wherein the adapter is formed from a first material and the riser is formed from a second material different from the first material.

10. A method for installing an underground storage system comprising the steps of:
attaching an adapter to a collar, the collar being attached to an underground storage tank, the adapter having an adapter top and an adapter bottom, the adapter bottom being sized and configured to mate with the collar, the adapter top including an inwardly projecting adapter flange; and
attaching a riser to the adapter, the riser having a sidewall including a bottom end and a top end, the bottom end having an annular, inwardly projecting riser flange attached thereto, the riser flange being sized to mate with the adapter flange.

11. The method of claim 10, wherein the underground storage tank includes a manway positioned in an interior of the collar.

12. The method of claim 10, wherein the adapter flange and the riser flange each have a plurality of corresponding holes formed therein and the riser is attached to the adapter using a plurality of fasteners, at least one of the fasteners being positioned in each of the corresponding holes.

13. The method of claim 10, further comprising the step of installing at least one double walled pipe having an inner pipe and an outer pipe forming an annular space therebetween, wherein the riser is adapted to form a containment sump together with the collar and the adapter, the double walled pipe being installed such that the annular space is in fluid communication with an interior of the containment sump.

14. The method of claim 10, wherein the underground storage tank is a double-walled underground storage tank.

15. The method of claim 10, wherein the adapter is attached to the collar prior to positioning the underground storage tank below ground level.

16. The method of claim 10, wherein the underground storage tank and the adapter are formed from fiber reinforced plastic (FRP).

17. The method of claim 16, wherein the riser is formed from FRP.

18. The method of claim 16, wherein the riser is formed from polypropylene.

19. The method of claim 10, wherein the adapter is formed from a first material and the riser is formed from a second material different from the first material.

20. A reverse flange collar adapter comprising:
a lower portion, the lower portion being sized and configured to mate with an attached collar of an underground storage tank; and
an upper portion, the upper portion having an inwardly projecting adapter flange sized to mate with an inwardly projecting riser flange.

21. An underground storage system comprising:
an underground storage tank, the underground storage tank having a collar attached thereto, the collar having a top, the top including an inwardly projecting collar flange; and
a riser, the riser having a sidewall including a bottom end and a top end, the bottom end having an annular, inwardly projecting riser flange attached thereto, the riser flange being sized and configured to mate with the collar flange.

22. The underground storage system of claim 21, wherein the underground storage tank includes a manway positioned in an interior of the collar.

23. The underground storage system of claim 21, further comprising a plurality of fasteners positioned to secure the collar flange to the riser flange, wherein the collar flange and the riser flange each have a plurality of holes formed therein, each of the holes being sized to accept at least one of the fasteners.

24. The underground storage system of claim 21, wherein the collar is formed from a first material and the riser is formed from a second material different from the first material.

25. A method for installing an underground storage system comprising the steps of:
attaching a collar to an underground storage tank, the collar having a collar top and a collar bottom, the collar top including an inwardly projecting collar flange; and
attaching a riser to the collar, the riser having a sidewall including a bottom end and a top end, the bottom end having an annular, inwardly projecting riser flange attached thereto, the riser flange being sized to mate with the collar flange.

26. The method of claim 25, wherein the underground storage tank includes a manway positioned in an interior of the collar.

27. The method of claim 25, wherein the collar flange and the riser flange each have a plurality of corresponding holes formed therein and the riser is attached to the collar using a plurality of fasteners, at least one of the fasteners being positioned in each of the corresponding holes.

28. The method of claim 25, wherein the collar is formed from a first material and the riser is formed from a second material different from the first material.
